(19) United States
(12) Patent Application Publication
(10) Pub. No.: US 2025/0392335 A1
(43) Pub. Date: Dec. 25, 2025

(54) ELECTRONIC DEVICE FOR SELF-INTERFERENCE CANCELLATION AND METHOD FOR SELF-INTERFERENCE CANCELLATION USING THE SAME

(71) Applicant: SAMSUNG ELECTRONICS CO., LTD., SUWON-SI (KR)

(72) Inventors: YOONSUK OH, SUWON-SI (KR); MYEONGGYUN CHOI, SUWON-SI (KR); HYUNG SUN LIM, SUWON-SI (KR); HONGMIN CHOI, SUWON-SI (KR); JOONHOI HUR, SUWON-SI (KR)

(21) Appl. No.: 19/083,502

(22) Filed: Mar. 19, 2025

(30) Foreign Application Priority Data
Jun. 20, 2024 (KR) 10-2024-0080479

(51) Int. Cl. H04B 1/10; H04B 1/04; H04B 1/525

(52) U.S. Cl. CPC H04B 1/1027; H04B 1/0475; H04B 1/525

(57) ABSTRACT

An electronic device includes a filter circuit extracting a duplex gap leakage (DGL) component present between a transmission channel for a transmission signal and a reception channel for a reception signal, from the reception signal, modeling an actual intermodulation distortion (IMD) component of the reception signal based on the transmission signal and the DGL component to generate an estimated IMD component, and a cancellation circuit performing a digital filtering operation on the estimated IMD component to generate a filtered IMD component and cancelling the filtered IMD component from the reception signal.

### CROSS-REFERENCE TO RELATED APPLICATIONS

This patent application claims priority under 35 U.S.C. § 119 to Korean Patent Application No. 10-2024-0080479 filed on Jun. 20, 2024, in the Korean Intellectual Property Office, the disclosure of which is incorporated by reference in its entirety herein.

### 1. TECHNICAL FIELD

Embodiments of the present disclosure described herein are directed to an electronic device for self-interference cancellation and a method for self-interference cancellation using the electronic device.

### DISCUSSION OF RELATED ART

A terminal is a device or endpoint that enables users to access, send, or receive data within a network. In general, the terminal may include a power amplifier (PA) to amplify a transmission signal. If the transmission signal becomes distorted (e.g., due to a nonlinearity of the PA), an out-of-band (OOB) emission may occur in adjacent channels. As an example of the OOB emission, a duplex gap leakage (DGL) refers to an unwanted signal emission that leaks into a duplex gap, which is a reserved frequency space between two frequency bands that are used for uplink and downlink communication. The DGL occurs as part of OOB emissions, specifically affecting the gap between uplink and downlink bands in systems that use frequency division duplexing (FDD).

A portion of the transmission signal that contributes to DGL may be referred to as a DGL component. The DGL component may generate an intermodulation distortion (IMD), and the generated IMD may act as self-interference in a reception channel, thereby reducing sensitivity of the reception signal. The sensitivity reduction of the reception signal due to the DGL component may be fatal to a communication environment with a narrow duplex spacing (e.g., FDD), or a communication environment where the transmission channel and the reception channel are close (e.g., intra-band non-contiguous carrier aggregation (CA)).

### SUMMARY

Embodiments of the present disclosure provide an electronic device for self-interference cancellation and a method for self-interference cancellation using the electronic device.

According to an embodiment, an electronic device includes a kernel generation module (e.g., a filter circuit) configured to extract a duplex gap leakage (DGL) component present between a transmission channel for a transmission signal and a reception channel for a reception signal, from the reception signal, to model a first intermodulation distortion (IMD) component with respect to the reception signal based on the transmission signal and the DGL component to generate a second IMD component, and a cancellation circuit configured to perform a digital filtering operation on the second IMD component to generated a fileted IMD component and to cancel the filtered IMD component from the reception signal.

According to an embodiment, a method of cancelling self-interference in a reception signal of an electronic device includes extracting a duplex gap leakage (DGL) component present between a transmission channel for a transmission signal and a reception channel for the reception signal, from the reception signal, modeling a first intermodulation distortion (IMD) component of the reception signal based on the transmission signal and the DGL component to generate a second IMD component, digitally filtering the second IMD component to generate a filtered IMD component, and cancelling the filtered IMD component from the reception signal.

According to an embodiment, a wireless communication device includes a front-end module configured to separate a transmission channel from a reception channel, to transmit a transmission signal to the transmission channel, and to receive a reception signal from the reception channel, a radio frequency integrated chip (RFIC) configured to perform a frequency conversion and an analog-to-digital conversion on the transmission signal and the reception signal, and a processor, based on the transmission signal and a duplex gap leakage (DGL) component present between the transmission channel and the reception channel in a digital domain according to the analog-to-digital conversion, configured to model a first intermodulation distortion (IMD) component of the reception signal to generate a second IMD component, to digitally filter the first IMD component to generate a filtered IMD component, and to cancel the filtered IMD component from the reception signal.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a wireless communication device according to an embodiment of the present disclosure;

FIG. 2 is a block diagram illustrating in detail the wireless communication device of FIG. 1;

FIG. 3 is a block diagram illustrating an electronic device according to embodiments of the present disclosure;

FIGS. 4 and 5 are views illustrating a waveform of a low-noise amplifier (LNA) of FIG. 2 in an intra-band non-contiguous carrier aggregation (CA);

FIG. 6 is a view illustrating an S-parameter of a front-end module (FEM);

FIG. 7 is a block diagram illustrating an electronic device according to an embodiment of the present disclosure;

FIG. 8 is a block diagram illustrating an electronic device according to an embodiment of the present disclosure;

FIG. 9 is a block diagram illustrating a kernel generation module of FIG. 7 or FIG. 8 according to an embodiment of the present disclosure;

FIG. 10 is a block diagram illustrating a synchronization module of FIG. 7 or FIG. 8 according to an embodiment of the present disclosure;

FIG. 11 is a flowchart illustrating an operation of an electronic device according to an embodiment of the present disclosure;

FIG. 12 is a flowchart illustrating a method of outputting a delay value of an electronic device according to an embodiment of the present disclosure;

FIG. 13 is a flowchart illustrating a method of generating a kernel of an electronic device according to an embodiment of the present disclosure;

FIG. 14 is a flowchart illustrating a method of generating a third IMD component according to embodiments of the present disclosure;

FIGS. 15 and 16 are views illustrating simulation waveforms according to a self-interference cancellation; and

FIG. 17 is a block diagram illustrating a wireless communication device according to an embodiment of the present disclosure.

### DETAILED DESCRIPTION

Below, embodiments of the present disclosure will be described in detail and clearly to such an extent that an ordinary one in the art may implement the present disclosure.

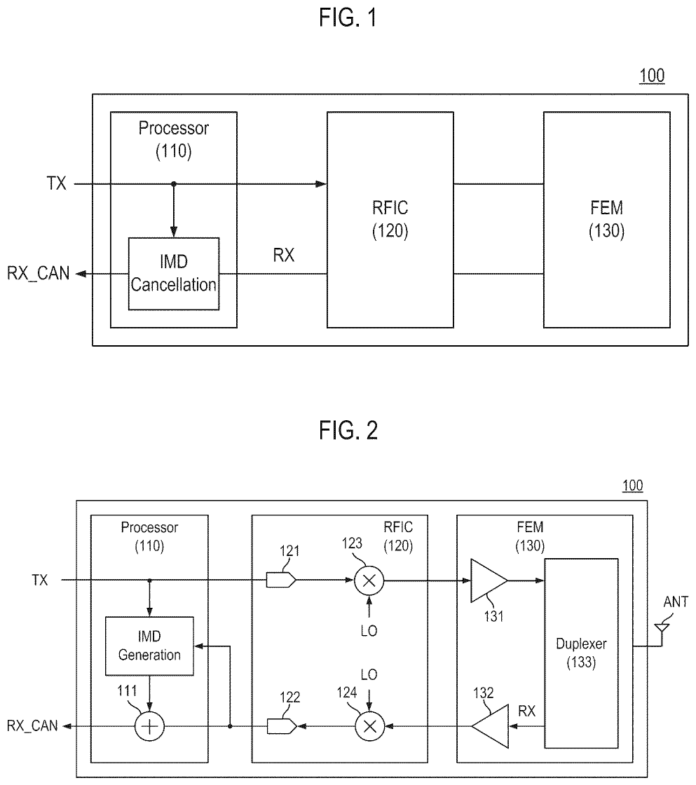

FIG. 1 is a block diagram illustrating a wireless communication device 100 according to an embodiment of the present disclosure.

Referring to FIG. 1, the wireless communication device 100 may include a processor 110, a radio frequency integrated chip (RFIC) 120, and a front-end module (FEM) 130.

Each of the processor 110, the RFIC 120, and the FEM 130 of the wireless communication device 100 may be implemented in an IC chip or module. In addition, the processor 110, the RFIC 120, and the FEM 130 may be mounted together on a printed circuit board (PCB), however, the present disclosure is not limited thereto. According to an embodiment, at least some of the processor 110, the RFIC 120, and the FEM 130 are implemented in a single communication chip.

In addition, the wireless communication device 100 illustrated in FIG. 1 may be included in a wireless communication system using a cellular network such as 5th-generation (5G), long term evolution (LTE), etc., or may be included in a wireless local area network system (WLAN) or any other wireless communication system. For reference, the configuration of the wireless communication device 100 illustrated in FIG. 1 is merely an example and is not limited thereto. For example, the wireless communication device 100 may be configured in various ways depending on a communication protocol or communication method.

The processor 110 may process a transmission signal TX including information to be transmitted or may process a reception signal RX that is received in a digital domain. As an example, the processor 110 may be referred to as a modem.

The RFIC 120 may perform a frequency conversion and an analog-to-digital conversion on the transmission signal TX and the reception signal RX. As an example, the RFIC 120 may perform a frequency up-conversion on the transmission signal TX or may perform a frequency down-conversion on the reception signal RX. The frequency up-conversion is a process of shifting a signal from a lower frequency to a higher frequency and the frequency down-conversion is a process of shifting a signal from a higher frequency to a lower frequency. The RFIC 120 may convert the transmission signal TX of the digital domain processed by the processor 110 into an analog domain or may convert the reception signal RX of the analog domain output from the FEM 130 into the digital domain.

The FEM 130 may separate a transmission channel from a reception channel, may transmit the transmission signal TX to the transmission channel, and may receive the reception signal RX from the reception channel. As an example, the FEM 130 may be implemented based on a duplexer or a switch structure that may separate each channel.

The FEM 130 may amplify the transmission signal TX or may amplify the reception signal RX with low noise. For the amplification, the FEM 130 may include a power amplifier (PA) and a low-noise amplifier (LNA) according to embodiments. The transmission signal TX may be distorted due to a nonlinearity of the PA, and the distortion may cause an out-of-band (OOB) emission in adjacent channels.

According to an embodiment, the FEM 130 has a transmit/receive duplex response characteristic with sharp characteristics in a duplex gap defined as a bandwidth between the transmission channel and the reception channel. In this case, the OOB emission due to a leakage component of the transmission signal TX may cause a duplex gap leakage (DGL) component at a significant level due to the duplex response characteristics. That is, the DGL component may present between the transmission channel and the reception channel and may be caused by the OOB emission of the leakage component of the transmission signal TX itself and the duplex response.

The DGL component may cause the leakage component and intermodulation (IMD) on the transmission signal TX, and the IMD component may act as a self-interference in the reception channel. The DGL component may be an unnecessary component from a perspective of a desired signal to be received and may be cancelled through various filters within the wireless communication device 100. However, when a level of the DGL component is sufficiently large, the IMD component may also have a significant impact on receiver sensitivity. The receiver sensitivity may be a measure of a receiver's ability to detect weak signals. It may be defined as the minimum signal power at which a receiver can effectively detect and demodulate a signal with an acceptable level of error or quality. Receiver sensitivity may be measured in decibels relative to one milliwatt (dBm). For example, a receiver with a sensitivity of −90 dBm can detect weaker signals than a receiver with a sensitivity of −80 dBm. Cancellation of the IMD component may be required when it has too large of an impact on receiver sensitivity.

According to an embodiment, the processor 110 models a first IMD component (e.g., an actual IMD) for the reception signal RX based on the transmission signal TX and the DGL component in the digital domain according to the analog-to-digital conversion. For example, the processor 110 may generate a representation of the IMD that might occur in the reception signal RX. In the present disclosure, the first IMD component may be the IMD component included in the reception signal RX from the FEM 130 and the RFIC 120. That is, the first IMD component refers to the IMD component included in the actual reception signal RX due to the leakage component of the transmission signal TX and the DGL component.

According to an embodiment, the processor 110 extracts the DGL component from the reception signal RX to model the first IMD component (e.g., the actual IMD component of the reception signal). The processor 110 may digitally filter a second IMD component (e.g., an estimated IMD component) according to the modeling operation and may cancel a third IMD component (e.g., a filtered IMD component) according to the digital filtering operation from the reception signal RX. That is, in the present disclosure, the second IMD component may mean the IMD component modeled or estimated based on the transmission signal TX and the DGL component by the processor 110, and the third IMD component may mean the IMD component obtained by applying the digital filtering operation to the second IMD component.

According to the above embodiments, the processor 110 may extract the DGL component separately from the reception signal RX and may model the IMD component using the extracted DGL component. In addition, the digital filtering operation may be performed to more accurately simulate the actual IMD component. As an example, an adaptive filtering operation may be applied to adaptively estimate a filter coefficient in the digital filtering operation. As a result, as the simulated IMD component is cancelled from the reception signal RX, the processor 110 may output a reception signal RX_CAN from which the IMD component is cancelled.

According to the above embodiments, the wireless communication device 100 may model the IMD component based on the DGL component that causes the IMD component on the reception channel and may cancel the modeled IMD component from the reception signal RX. Therefore, the receiving sensitivity performance for the reception signal RX may be increased even in various scenarios where the DGL component occurs.

FIG. 2 is a block diagram illustrating in detail the wireless communication device 100 of FIG. 1.

Referring to FIG. 2, the processor 110 may process the transmission signal TX in the digital domain and may output the processed transmission signal TX to the RFIC 120. In addition, the processor 110 may process the reception signal RX in the digital domain.

The RFIC 120 may include a digital-to-analog converter (DAC) 121, an analog-to-digital converter (ADC) 122, a first mixer 123, and a second mixer 124. The RFIC 120 may include at least one DAC 121 and at least one ADC 122. The FEM 130 may include the PA 131, the LNA 132, and the duplexer 133.

Hereinafter, a transmission path is described. The DAC 121 may convert the transmission signal TX in a baseband (e.g., a baseband frequency) into an analog signal. The first mixer 123 may perform frequency up-conversion, which converts a frequency of the analog-converted transmission signal TX from the baseband to a high-frequency band in response to a frequency signal provided by a local oscillator LO.

The PA 131 may receive a direct current (DC) voltage or a variable power supply voltage, i.e. a dynamically variable output voltage, and may secondarily amplify the power of the up-converted transmission signal TX based on the power supply voltage applied thereto. The PA 131 may provide the amplified transmission signal TX to the duplexer 133. However, as described above, the OOB emission may occur in the amplification process due to the nonlinearity of the PA 131. Even after the OOB emission passes through the duplexer 133, a portion of the OOB emission may reach the LNA 132, and the OOB emission that reaches the LNA 132 may act as the self-interference. The OOB emission may include the DGL component.

For reference, the wireless communication device 100 may transmit the transmission signal TX over multiple frequency bands using carrier aggregation (CA) technology. To this end, the wireless communication device 100 may include multiple power amplifiers (PAS) 131 to power-amplify multiple transmission signals TX respectively corresponding to a plurality of carriers. However, for convenience of explanation, a structure in which the FEM 130 includes one PA 131 will be described as a representative example.

The duplexer 133 may be connected to an antenna ANT and may separate a transmission frequency from a reception frequency. In detail, the duplexer 133 may separate the amplified transmission signal TX provided from the PA 131 for each frequency band and may provide the separated transmission signal TX to a corresponding antenna ANT. For example, different antennas may be optimized for different frequency bands (e.g., low-band, mid-band, high-band frequencies), and by sending each separated signal to its corresponding antenna, the device can ensure efficient transmission for each band.

According to an embodiment, the wireless communication device 100 includes a switch structure capable of separating the transmission frequency and the reception frequency instead of the duplexer 133. In addition, the wireless communication device 100 may include the duplexer 133 and the switch structure to separate the transmission frequency and the reception frequency. However, for convenience of explanation, in the following descriptions, a structure in which the duplexer 133 capable of separating the transmission frequency and the reception frequency is provided in the wireless communication device 100 will be described as a representative example.

The antenna ANT may transmit the transmission signal TX that is frequency-separated by the duplexer 133 to the outside. As an example, the antenna ANT may include an array antenna, however, the present disclosure is not limited thereto.

The antenna ANT may provide the reception signal RX applied thereto from the outside to the duplexer 133. The duplexer 133 may provide the reception signal RX from the antenna ANT to the LNA 132.

The LNA 132 may amplify the reception signal RX provided from the duplexer 133 with low noise and may provide the amplified reception signal RX to the second mixer 124. The second mixer 124 may perform the frequency down-conversion to convert a frequency of the reception signal RX from a high frequency band to a baseband in response to the frequency signal provided by the local oscillator LO. That is, the second mixer 124 may convert the reception signal RX to a baseband signal in response to an LO signal.

Through the frequency down-conversion, the reception signal RX corresponding to the baseband signal may be digitally converted through the ADC 122. The digital-converted reception signal RX may be provided to the processor 110.

According to an embodiment, the transmission signal TX and the reception signal RX in the digital domain are used for modeling and cancelling the IMD component. The processor 110 may model the IMD component using the transmission signal TX before it is digital-to-analog converted by the DAC 121 and the reception signal RX in the digital domain digitally converted by the ADC 122. The reception signal RX in the digital domain may include the DGL component, and the processor 110 may extract the DGL component from the reception signal RX in the digital domain. The processor 110 may model the first IMD component included in the reception signal RX using the extracted DGL component and the transmission signal TX to generate the second IMD component.

The processor 110 may digitally filter the second IMD component to extract the third IMD component, and a reception signal RX_CAN obtained by cancelling the third IMD component from the reception signal RX may be output through an adder 111.

As a result, since the IMD component, which is a self-interference signal included in the reception signal RX separated by the duplexer 133, i.e., the IMD component caused by the leakage component of the transmission signal TX and DGL component, is cancelled from the reception signal RX, the receiving sensitivity may be increased. In addition, even in a communication environment where the self-interference intensifies, such as an in-band full duplex or a sub-band full duplex, the receiving sensitivity may be increased by cancelling the IMD component.

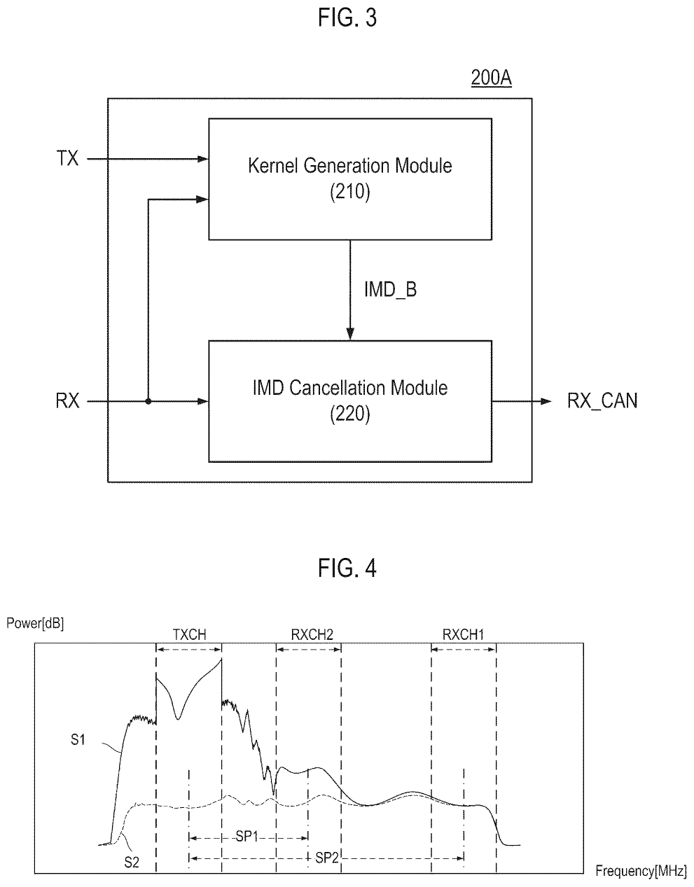

FIG. 3 is a block diagram illustrating an electronic device 200A according to an embodiment of the present disclosure.

Referring to FIG. 3, the electronic device 200A may include a kernel generation module 210 (e.g., a filter circuit) and an IMD cancellation module 220 (e.g., a cancelation circuit). The reception signal RX of the digital domain may be commonly provided to the kernel generation module 210 and the IMD cancellation module 220 to generate and cancel a kernel. In addition, according to the present disclosure, the kernel may mean a signal, for example, the second IMD component IMD_B, to be subjected to the digital filtering operation via the IMD cancellation module 220.

In an embodiment, the kernel generation module 210 extracts the IMD component of the reception signal RX based on the transmission signal TX and the reception signal RX. First, the kernel generation module 210 may extract the DGL component from the reception signal RX. According to an embodiment, the kernel generation module 210 extracts the DGL component, which is a signal corresponding to the duplex gap, based on a transition of a center frequency and a low-pass filtering with respect to the reception signal RX.

The kernel generation module 210 may model the first IMD component included in the reception signal RX based on the extracted DGL component and the transmission signal TX. As an example, the kernel generation module 210 may perform a modeling process to model the first IMD component based on the DGL component and the transmission signal TX and may output the second IMD component IMD_B according to a result of the modeling process.

The IMD cancellation module 220 may digitally filter the second IMD component IMD_B output from the kernel generation module 210 and may cancel the third IMD component IMD_C according to the filtering operation from the reception signal RX. That is, the IMD cancellation module 220 may receive the reception signal RX and the second IMD component IMD_B to cancel the third IMD component IMD_C from the received reception signal RX.

According to an embodiment, the IMD cancellation module 220 performs the digital filtering operation to allow the second IMD component IMD_B to more accurately simulate the first IMD component included in the reception signal RX. As an example, the digital filtering operation may be performed based on at least one of a finite impulse response (FIR) filter to reflect a memory effect or an adaptive filter to adjust a filter coefficient. Through the digital filtering operation, the third IMD component IMD_C, which is closer to the first IMD component, may be output.

According to an embodiment, the adaptive filter may be implemented based on a least square (LS) method or a minimum mean squared error (MMSE) method, or may include a least mean square (LMS) adaptive filter or a recursive least square (RLS) adaptive filter.

According to an embodiment, the IMD cancellation module 220 generates and output the third IMD component IMD_C based on a neural network and a data-driven based machine learning technique.

According to the above embodiments, the electronic device 200A may extract the DGL component separate from the reception signal RX and may cancel the IMD component from the reception signal RX based on the extracted DGL component. Therefore, the receiving sensitivity performance may be increased even in communication scenarios where the self-interference caused by the DGL component is present.

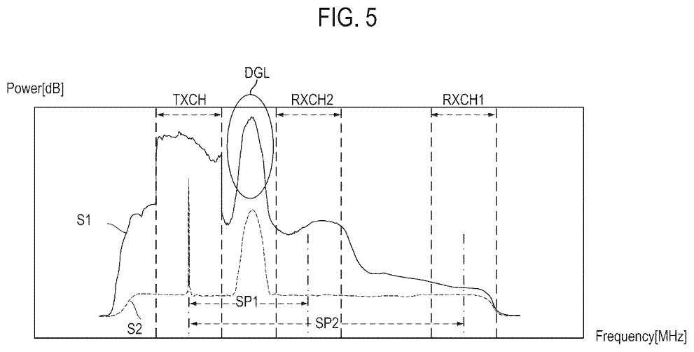

FIGS. 4 and 5 are views illustrating a waveform of the low-noise amplifier (LNA) of FIG. 2 in the intra-band non-contiguous carrier aggregation (CA).

Referring to FIGS. 4 and 5, two reception channels may be allocated for a transmission channel TXCH with an uplink primary component carrier (UL PCC) due to the non-contiguous CA. The two reception channels may include a first reception channel RXCH1 having a downlink (DL) PCC and a second reception channel RXCH2 having a DL secondary component carrier (SCC) corresponding to the DL PCC. Assuming that a frequency division duplex (FDD) is used, transmission and reception channels may be separated on a frequency axis. In addition, the DL SCC may be allocated closer to the UL PCC than the DL PCC is. In addition, a first signal S1 may be the output of the LNA when the PA is turned on, and a second signal S2 may be the output of the LNA when the PA is turned off.

Referring to FIG. 4, the effect of the interference caused by the transmission channel TXCH on the first reception channel RXCH1, i.e., the OOB emission, may be considered to be small by taking into account a duplex spacing SP2 between the UL PCC and the DL PCC. However, considering a spacing SP1 between the DL SCC, which is closer to the UL PCC than the DL PCC, and the UL PCC, it is observed that there is the interference component in the second reception channel RXCH2 due to the OOB emission of the transmission channel TXCH. Due to the interference component, the receiving sensitivity in the second reception channel RXCH2 deteriorate.

Further, the DGL component DGL with a level almost equal to a level of the leakage component of the transmission signal may occur between the transmission channel TXCH and the second reception channel RXCH2, i.e., in the duplex gap, as shown in FIG. 5. Different from the waveform of FIG. 4, due to the DGL component DGL, a high-level signal component may occur between the transmission channel TXCH and the second reception channel RXCH2 regardless of whether the PA is turned on or off.

The DGL component DGL may generate the IMD with the leakage component of the transmission signal, and the generated IMD may act as the self-interference in the reception channel, thereby deteriorating the sensitivity of the reception signal. In particular, the second reception channel RXCH2 adjacent to the transmission channel TXCH may be significantly affected by the OOB emission due to the IMD caused by the DGL component and the leakage component of the transmission signal.

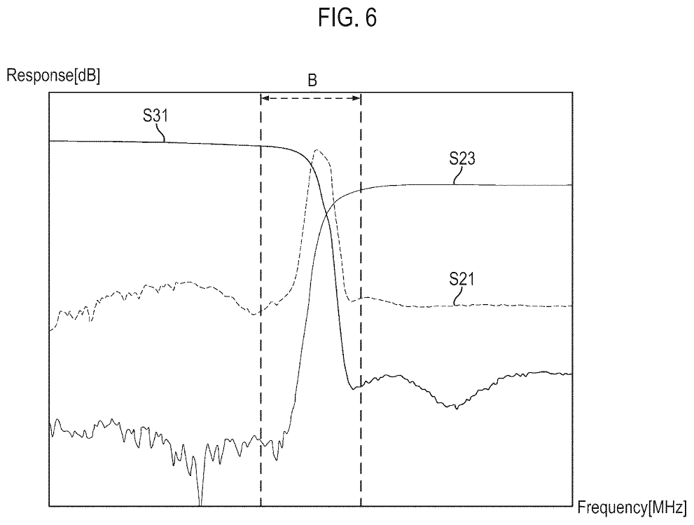

FIG. 6 is a view illustrating an S-parameter of the front-end module (FEM).

Referring to FIG. 6, a parameter S21 is a response of the input of the PA (e.g., 131) and the output of the LNA (e.g., 132), a parameter S31 is a response of the input of the PA and the output of the duplexer (e.g., 133), and a parameter S23 is a response of the output of the LNA and the output of the duplexer. Assuming that an ideal FEM is used, the parameter S21 may have a flat shape different from that shown in FIG. 6 to prevent the reflection of the transmission signal. However, when the parameter S21 has a sharp shape in a specific band B as shown in FIG. 6 according to the design of FEM, the OOB emission of the transmission signal may cause the DGL component.

The electronic device according to the above embodiments of FIGS. 1 to 3 may model the self-interference component using the DGL component described with reference to FIGS. 4 to 6 and thus may cancel the self-interference.

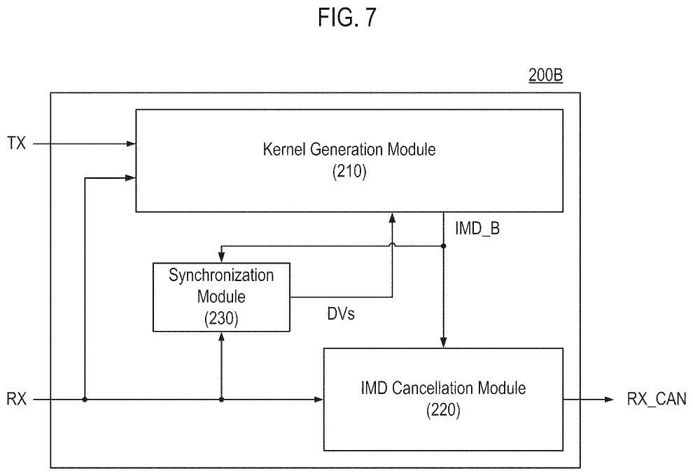

FIG. 7 is a block diagram illustrating an electronic device 200B according to an embodiment of the present disclosure.

Referring to FIG. 7, the electronic device 200B may further include a synchronization module 230 (e.g., a synchronization circuit) in addition to the kernel generation module 210 and the IMD cancellation module 220 of FIG. 6.

The synchronization module 230 may perform a time synchronization between an IMD component modeled through the kernel generation module 210, i.e. a second IMD component IMD_B, and a self-interference component included in a reception signal, i.e. a first IMD component. That is, the synchronization module 230 may perform operations to synchronize a time between the second IMD component IMD_B extracted by simulating the IMD component in the actual reception signal and the first IMD component, which is the self-interference component to be cancelled in the reception signal, i.e., an IMD component from a DGL component and a leakage component of a transmission signal.

The synchronization module 230 may output a first delay value and a second delay value for the time synchronization between the first IMD component and the second IMD component IMD_B. In the present embodiment, the first delay value is applied to the transmission signal, and the second delay value is applied to the DGL component.

According to an embodiment, the synchronization module 230 calculates the first delay value and the second delay value through a correlation operation between the first IMD component and the second IMD component IMD_B. In detail, the synchronization module 230 may calculate a correlation output value through the correlation operation between the first IMD component and the second IMD component IMD_B and may output the first delay value and the second delay value, which correspond to a maximum correlation output value. That is, the synchronization module 230 may provide the time synchronization by calculating time delay values DVs corresponding to when a correlation between the first IMD component and the second IMD component IMD_B is the highest.

As an example, the synchronization module 230 may perform the correlation operation and the calculation of the delay values DVs while delaying the first IMD component and/or the second IMD component IMD_B by a specific time delay value.

The first delay value and the second delay value calculated by the synchronization module 230 may be provided to the kernel generation module 210. The kernel generation module 210 may apply the first delay value to the transmission signal TX and may apply the second delay value to the DGL component. Accordingly, the kernel generation module 210 may model the first IMD component using the transmission signal TX and the DGL component that is time-synchronized with the transmission signal TX, and thus may output the second IMD component IMD_B that is time-synchronized with the actual IMD component.

In addition, the IMD cancellation module 220 may obtain a third IMD component IMD_C, which is to be finally cancelled, using the time-synchronized second IMD component IMD_B, and thus, a cancellation performance with respect to the IMD component may be further increased.

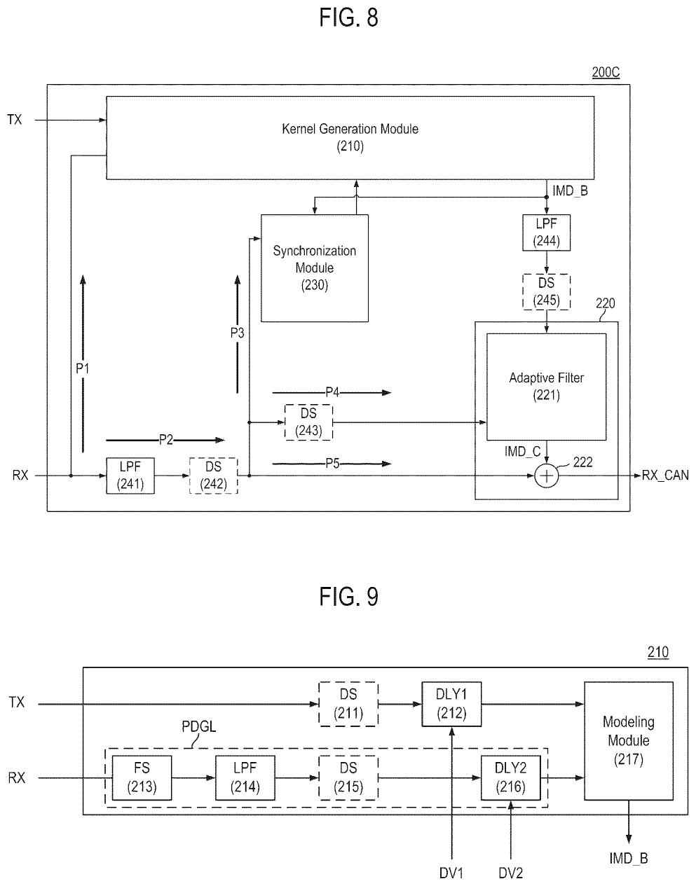

FIG. 8 is a block diagram illustrating an electronic device 200C according to an embodiment of the present disclosure.

Referring to FIG. 8, the electronic device 200C may include a kernel generation module 210, an IMD cancellation module 220, and a synchronization module 230 and may further include a plurality of low-pass filters and a plurality of down samplers. The low-pass filters and the down samplers may be provided on various paths formed between the kernel generation module 210, the IMD cancellation module 220, and the synchronization module 230.

According to embodiments, some of the down samplers may be omitted.

According to embodiments, a reception signal in a digital domain may be transmitted and processed through five paths in the electronic device 200C.

A first path P1 may be connected to the kernel generation module 210, and a reception signal (hereinafter, referred to as a first reception signal) initially transmitted to the first electronic device 200C may be transmitted as is through the first path P1. The first reception signal may include a target reception signal corresponding to a reception channel and a first IMD component and may also include components with a band higher than the reception channel. In an embodiment, the kernel generation module 210 extracts a DGL component from the first reception signal and outputs a second IMD component IMD_B using the extracted DGL component and a transmission signal TX.

A second path P2 may include a low-pass filter 241 and a down sampler 242 (e.g., a digital signal processor). The first reception signal passing through the low-pass filter 241 and the down sampler 242 may be referred to as a second reception signal.

The low-pass filter 241 may output the second reception signal obtained by filtering the first reception signal through a low-pass filtering to the synchronization module 230 and the IMD cancellation module 220. The second reception signal may include only the target reception signal and the first IMD component due to the low-pass filter 241. For example, signals with frequencies higher than a cutoff frequency of the low-pass filter 241, i.e. high-band components included in the first reception signal, may be filtered out.

In addition, the first reception signal, which may be relatively oversampled, may be down-sampled via the down sampler 242. However, the down sampler 242 may be omitted in other embodiments.

The second path P2 may be connected to third, fourth, and fifth paths P3, P4, and P5. Since the third path P3 is connected to the synchronization module 230, the second reception signal may be applied directly to the synchronization module 230. For example, the second reception signal may be applied directly from the low-pass filter 241 or directly from the down sampler 242, to the synchronization module 230.

The fourth path P4 may include a down sampler 243. A third reception signal obtained by down-sampling the second reception signal may be applied to an adaptive filter 221 included in the IMD cancellation module 220 through the fourth path P4.

The IMD cancellation module 220 may include the adaptive filter 221 and an adder 222.

The adaptive filter 221 may include a plurality of memory taps to reflect the memory effect and may perform a digital filtering operation based on the memory taps.

The memory taps may be a digital filter, e.g., a Finite Impulse Response (FIR) filter. A tap coefficient of each memory tap may be updated by the adaptive filter 221. When the second IMD component IMD_B is applied to the memory taps, the digital filtering operation may be performed on the second IMD component IMD_B.

The adaptive filter 221 may receive the reception signal through the fourth path P4. In this case, the reception signal provided through the fourth path may include the first IMD component and the target reception signal, which remain through the low-pass filtering operation. The adaptive filter 221 may reduce an error between the first IMD component and the second IMD component IMD_B by adjusting at least one of the tap coefficients of the memory taps. Finally, a third IMD component IMD_C, which is close to the actual IMD component, may be output through the adaptive filter 221.

The fifth path P5 may be connected to the adder 222 included in the IMD cancellation module 220. That is, the second reception signal may be provided to the adder 222, and the adder 222 may cancel the third IMD component IMD_C from the second reception signal to output a reception signal RX_CAN from which the IMD component is cancelled. In an alternate embodiment, the adder 222 is replaced with a subtractor that subtracts the third IMD component IMD_C from the second reception signal.

According to an embodiment, a low-pass filter 244 and a down sampler 245 are provided on a path through which the second IMD component IMD_B is output and provided to the IMD cancellation module 220.

The low-pass filter 244 may perform a low-pass filtering operation on the second IMD component IMD_B and provide a result of the low-pass filtering operation to the IMD cancellation module 220. The low-pass filter 244 may filter a bandwidth of the second IMD component IMD_B, which may be wider than the reception channel, through the IMD modeling operation. In addition, when present, the down sampler 245 may down-sample the second IMD component IMD_B that may be oversampled. According to the above embodiments, the electronic device 200C may provide appropriate receiving circuits required for each component, e.g., the kernel generation module 210, the synchronization module 230, the IMD cancellation module 220, etc., through various paths, e.g., the first to fifth paths P1 to P5. As an example, the kernel generation module 210 may extract the DGL component from the first reception signal, and the synchronization module 230 may precisely perform the synchronization operation in response to the second reception signal corresponding to the reception channel. The IMD cancellation module 220 may cancel the IMD component through the second reception signal and the third reception signal. The down sampler 245 may be omitted in alternate embodiments.

FIG. 9 is a block diagram illustrating the kernel generation module 210 according to an embodiment of the present disclosure.

Referring to FIG. 9, the kernel generation module 210 may include a down sampler 211, a first delayer 212 (e.g., a first delay circuit), a frequency shifter 213 (e.g., a mixer), a low-pass filter 214, a down sampler 215, a second delayer 216 (e.g., a second delay circuit), and a modeling module 217 (e.g., a logic circuit). In the present embodiment, the frequency shifter 213, the low-pass filter 214, the down sampler 215, and the second delayer 216 may form a DGL path PDGL.

According to embodiments, at least one of the down samplers may be omitted.

The transmission signal may be provided to the modeling module 217 through the down sampler 211 and the first delayer 212. The down sampler 211 may down-sample the transmission signal that may be oversampled and may output the down-sampled transmission signal to the first delayer 212. The first delayer 212 may apply the first delay value DV1 to the transmission signal. For example, the first delayer 212 may delay the transmission signal by an amount of time based on the first delay value DV1. The first delay value DV1 may be provided from the synchronization module 230 according to the above embodiments.

Then, the DGL component may be extracted from the reception signal through the DGL path PDGL. The frequency shifter 213 may shift a center frequency of the reception signal to a center frequency of the DGL component. For example, the shift may cause the center frequency of the reception signal to match a center frequency of the DGL component. Accordingly, when the low-pass filtering operation is appropriately performed on the shifted reception signal, only the DGL component may be left from the reception signal.

The low-pass filter 214 may output the DGL component by performing the low-pass filtering operation on the shifted reception signal. As an example, the low-pass filter 214 may have a cutoff frequency set to a value to separate the DGL component from the reception channel.

The second delayer 216 may apply the second delay value DV2 to the extracted DGL component. For example, the second delayer 216 may delay the extracted DGL component by an amount of time based on the second delay value DV2. The second delay value DV2 may be provided from the synchronization module 230 according to the above embodiments.

The modeling module 217 may model the first IMD component based on the transmission signal to which the first delay value DV1 is applied and the DGL component to which the second delay value DV2 is applied. The second IMD component IMD_B may be finally output through the modeling operation.

According to an embodiment, the modeling module 217 performs the modeling operation based on a location in a frequency range of the transmission channel and the reception channel.

As an example, the modeling module 217 (e.g., a modelling or logic circuit) may multiply a square of the DGL component by a conjugate (e.g., a complex conjugate) of the transmission signal based on that the transmission channel is located in a lower frequency range than the reception channel to generate the second IMD component IMD_B. Squaring the DGL component (i.e., multiplying it by itself) modifies its frequency characteristics and produces additional frequency components. Multiplying by the conjugate of the transmission signal allows the system to create interference components that mirror the behavior of the transmission signal. When the DGL component is defined as x[n] and the transmission signal is defined as y[n] z[n], the second IMD component IMD_B may be (x[n])²y*[n]. In this case, “n” is an integer number.

According to the embodiments, the kernel generation module 210 may extract the DGL components separately from the receiving circuit through the DGL path PDGL separately provided. Therefore, the IMD component that needs to be cancelled to increase the receiver sensitivity may be accurately modeled.

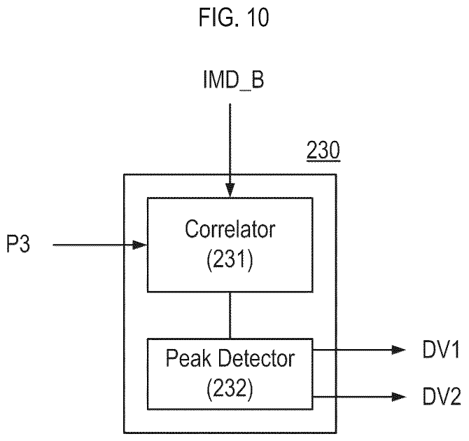

FIG. 10 is a block diagram illustrating the synchronization module 230 according to an embodiment of the present disclosure.

Referring to FIG. 10, the synchronization module 230 may include a correlator 231 and a peak detector 232. For example, then correlator 231 may be implemented by correlator circuit, a DSP, a field programmable gate array, analog multiplier and integrator circuits, etc. For example, the peak detector 232 may be implemented by a peak detector circuit, diode-capacitor circuits, operational amplifiers, sample-and-hold circuits, a DSP, envelope detectors, etc.

The correlator 231 may receive the reception signal via the third path P3 (refer to FIG. 8) and may receive the second IMD component IMD_B from the kernel generation module 210 (refer to FIGS. 7 to 9). In this case, the reception signal provided via the third path P3 may include the first IMD component and the target reception signal, which are left through the low-pass filtering operation. The correlator 231 may calculate a correlation output value through a correlation operation between the first IMD component and the second IMD component IMD_B. As an example, the correlator 231 may perform the correlation operation by delaying the first IMD component and/or the second IMD component IMD_B by a specific time delay value and may provide a correlation output value and a delay value according to the correlation operation to the peak detector 232.

The peak detector 232 may output delay values corresponding to the maximum correlation output value among the correlation output values provided by the correlator 231 as the first delay value DV1 and the second delay value DV2. The first delay value DV1 and the second delay value DV2 may be finally provided to the kernel generation module 210 and may be used for the time synchronization.

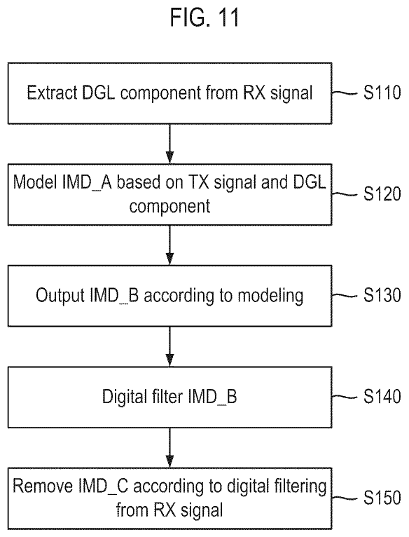

FIG. 11 is a flowchart illustrating an operation of the electronic device according to an embodiment of the present disclosure.

Referring to FIG. 11, in operation S110, the electronic device extracts the DGL component, which is present between the transmission channel for the transmission signal and the reception channel for the reception signal, from the reception signal.

In operation S120, the electronic device models the first IMD component IMD_A with respect to the reception signal based on the transmission signal and the DGL component. In operation S130, the electronic device outputs the second IMD component IMD_B according to a result of the modeling operation.

In operation S140, the electronic device digitally filters the second IMD component IMD_B. The third IMD component IMD_C close to the actual first IMD component IMD_A may be output through the digital filtering operation.

In operation S150, the electronic device cancels or removes the third IMD component IMD_C according to the digital filtering operation from the reception signal.

According to the operation method, since the DGL component is extracted from the reception signal and the self-interference signal is cancelled from the reception signal using the extracted DGL component, the receiver sensitivity may be increased.

According to the above embodiments, the operation method may further include outputting the first delay value and the second delay value for the time synchronization of the first IMD component IMD_A and the second IMD component IMD_B.

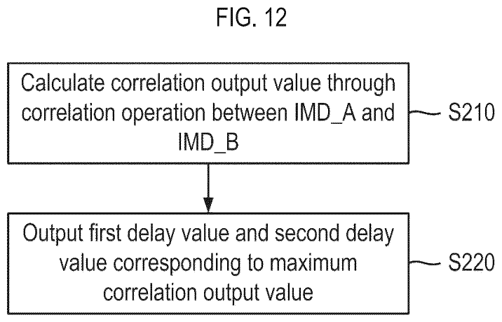

FIG. 12 is a flowchart illustrating a method of outputting the delay value of the electronic device according to an embodiment of the present disclosure.

Referring to FIG. 12, in operation S210, the electronic device calculates the correlation output value based on the correlation operation between the first IMD component IMD_A and the second IMD component IMD_B. The calculation operation (S210) may be performed repeatedly while delaying the first IMD component IMD_A and/or the second IMD component IMD_B by the specific time delay value in a time domain.

In operation S220, the electronic device outputs the first delay value and the second delay value, which correspond to the maximum correlation output value. The first delay value and the second delay value may be used for the time synchronization. In an embodiment, the first and second delay values are different from one another, but both exceed a threshold value to be considered maximum correlation output values.

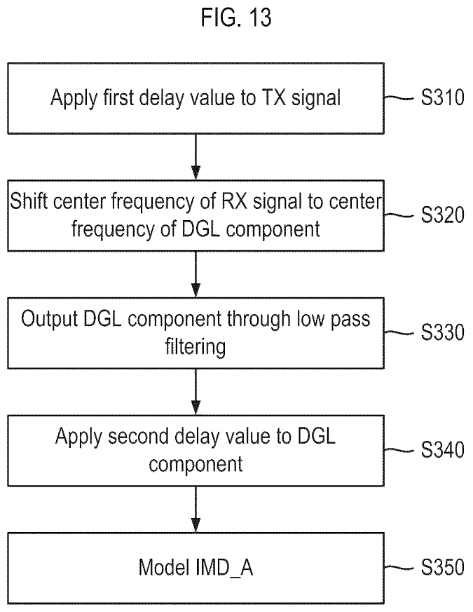

FIG. 13 is a flowchart illustrating a method of generating the kernel of the electronic device according to an embodiment of the present disclosure.

Referring to FIG. 13, in operation S310, the electronic device applies the first delay value to the transmission signal. For example, the electronic device may delay the transmission signal by an amount of time based on the first delay value. The transmission signal to which the first delay value is applied may be used to model the first IMD component IMD_A.

In operation S320, the electronic device shifts the center frequency of the reception signal to the center frequency of the DGL component to generate a shifted reception signal. In operation S330, the electronic device outputs the DGL component through the low-pass filtering operation of the shifted reception signal. That is, the DGL component may be extracted from the reception signal through operations S320 and S330.

In operation S340, the electronic device applies the second delay value to the DGL component. For example, the electronic device may delay the DGL component by an amount of time based on the second delay value.

In operation S350, the electronic device models the first IMD component IMD_A based on the transmission signal to which the first delay value is applied through operations S310 and the DGL component to which the second delay value is applied through operations S340.

According to an embodiment, the electronic device compares a frequency range of the transmission channel to a frequency range of the reception channel in operation S350. In the case where the transmission channel is located in a lower frequency range than the reception channel, the modeling operation may be performed based on the multiplication of the square of the DGL component by the conjugate of the transmission signal. In the case where the transmission channel is located in a higher frequency range than the reception channel, the modeling operation may be performed based on the multiplication of the conjugate of the DGL component by the square of the transmission signal.

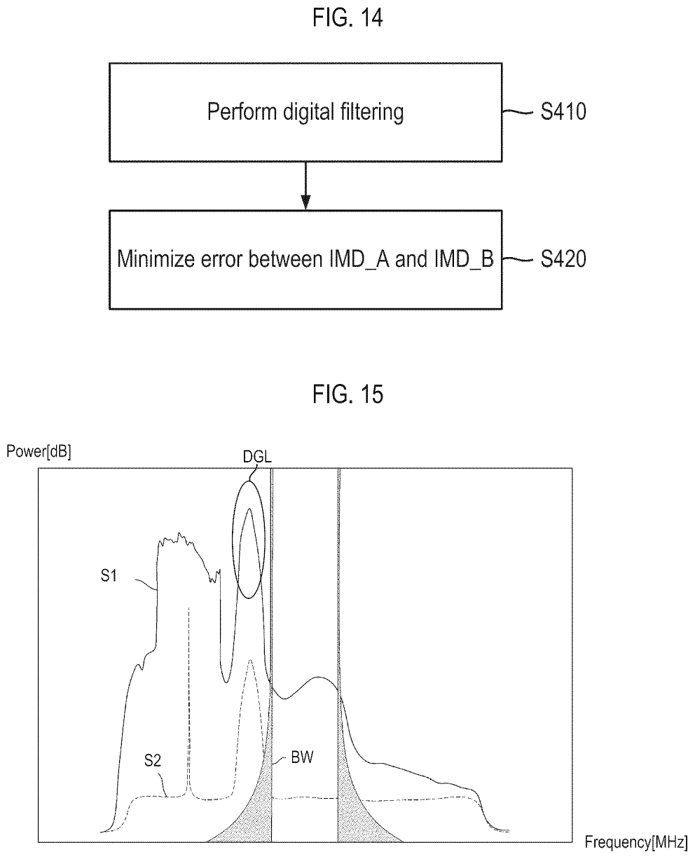

FIG. 14 is a flowchart illustrating a method of generating the third IMD component according to an embodiment of the present disclosure.

Referring to FIG. 14, the electronic device performs the digital filtering operation using the digital filter including the plurality of memory taps in operation S410. As an example, the digital filter may be the FIR filter.

In operation S420, the electronic device reduces or minimizes the error between the first IMD component IMD_A and the second IMD component IMD_B based on adjusting at least one of the tap coefficients of the memory taps. The third IMD component IMD_C with reduced error may be output in operation S420.

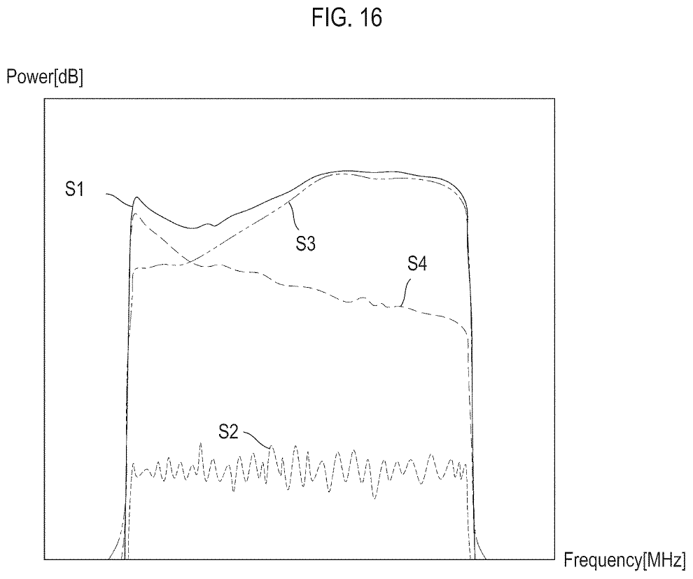

FIGS. 15 and 16 are views illustrating simulation waveforms according to a self-interference cancellation. In FIG. 15 and FIG. 16, the horizontal axis represents frequency such as in a megahertz (MHz) range and the vertical axis represents power ratios of signals in decibels (dB).

Referring to FIG. 15, the first signal S1 may be the output of the LNA (e.g., 132) when the PA (e.g., 131) is turned on, and the second signal S2 may be the output of the LNA when the PA is turned off. It may be observed that a significant level of the DGL component is present in the first signal S1. The DGL component DGL may cause the IMD component with significant level, i.e., self-interference, at a target receive bandwidth BW.

Referring to FIG. 16, the IMD component may be cancelled by extracting the DGL component DGL according to the above embodiments. The first signal S1 may indicate the reception signal in the receive bandwidth BW of FIG. 15. That is, the target reception signal and the IMD component are present in the first signal S1. The third signal S3 in FIG. 16 may be the third IMD component IMD_C generated according to the above embodiments.

The fourth signal S4 may be a reception signal finally obtained by cancelling the IMD component from the reception signal. As shown in FIG. 16, the fourth signal S4 may have a waveform obtained by cancelling the third signal S3 from the first signal S1. That is, different from the first signal S1 where the self-interference is present in the receive bandwidth BW due to the DGL component and the leakage component of the transmission signal, the self-interference may be cancelled from the third signal S3. The third signal S3 from which the self-interference is cancelled may have a similar level to the first signal S1 except for the receive bandwidth BW.

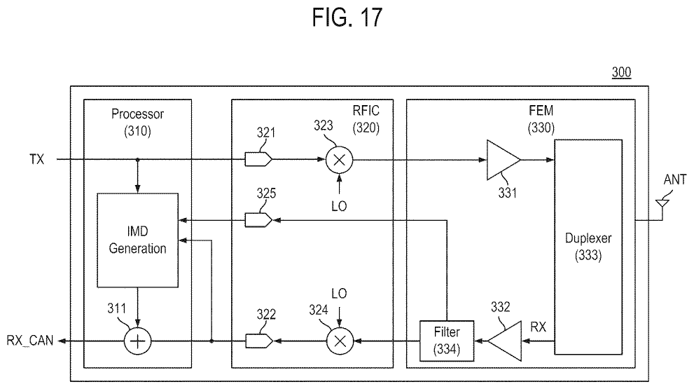

FIG. 17 is a block diagram illustrating a wireless communication device 300 according to an embodiment of the present disclosure. Hereinafter, detailed descriptions of the same elements as in the above embodiments will be omitted.

Referring to FIG. 17, the wireless communication device 300 may include a processor 310, an RFIC 320, and an FEM 330 and may include a separate analog path to extract a DGL component.

The analog path may be formed separately from a transmission path formed by a DAC 321, a first mixer 323, and a PA 331. The analog path may include a DGL filter 334 filtering an output of an LNA 332 and an additional ADC 325.

The DGL filter 334 may filter the DGL component from the output of the LNA 332 with respect to a reception signal RX to generate a filtered DGL component and may provide the filtered DGL component to the ADC 325. The ADC 325 may convert the DGL component to a digital domain and may provide the converted DGL component to the processor 310. That is, the RFIC 320 may provide the DGL component output from the DGL filter 334 to the processor 310 via the ADC 325.

The processor 310 may extract an IMD component based on a transmission signal TX and the DGL component obtained through the analog path and may cancel the IMD component from the reception signal via an adder 311, and thus, the processor 310 may output a reception signal RX_CAN from which the IMD component is cancelled. In an embodiment, the adder 311 is replaced with a subtractor to perform the cancellation.

According to the above embodiments, the DGL component may be extracted through the analog path that is separate from the transmission path and the reception path including the LNA 332, the DGL filter 334, a second mixer 324, and the ADC 322. Accordingly, the DGL component is cancelled from the reception path, and thus, a sampling rate of the reception path may be reduced.

Although embodiments of the present disclosure have been described, it is understood that the present disclosure is not limited to these embodiments but various changes and modifications can be made by one ordinary skilled in the art within the spirit and scope of the present disclosure. Therefore, the disclosed subject matter is not limited to any single embodiment described herein.

What is claimed is:

1. An electronic device comprising:
a filter circuit configured to extract a duplex gap leakage (DGL) component present between a transmission channel for a transmission signal and a reception channel for a reception signal, from the reception signal, to model a first intermodulation distortion (IMD) component of the reception signal based on the transmission signal and the DGL component to generate a second IMD component; and
cancellation circuit configured to perform a digital filtering operation on the second IMD component to generate a filtered IMD component and to cancel the filtered IMD component from the reception signal.

2. The electronic device of claim 1, further comprising a synchronization circuit configured to output a first delay value and a second delay value for a time synchronization between the first IMD component and the second IMD component, wherein the first delay value is to be applied to the transmission signal, and the second delay value is to be applied to the DGL component.

3. The electronic device of claim 2, wherein the synchronization circuit is configured to calculate correlation output values through a correlation calculation of the first IMD component and the second IMD component and to output the first and second delay values among the calculated correlation output values that exceed a threshold.

4. The electronic device of claim 2, wherein the filter circuit comprises:
a first delay circuit delaying the transmission signal based on the first delay value to generate a delayed transmission signal;
a frequency shifter shifting a center frequency of the reception signal to a center frequency of the DGL component to generate a shifted reception signal;
a first low-pass filter performing a low pass filtering operation on the shifted reception signal for outputting the DGL component;
a second delay circuit delaying the DGL component based on the second delay value to generate a delayed DGL component; and
a logic circuit modeling the first IMD component based on the delayed transmission signal and the delayed DGL component.

5. The electronic device of claim 1, wherein the cancellation circuit is configured to perform the digital filtering operation using a digital filter comprising a plurality of memory taps and to reduce an error between the first IMD component and the second IMD component based on adjusting at least one of tap coefficients of the memory taps.

6. The electronic device of claim 2, further comprising a second low-pass filter outputting the reception signal filtered through a low-pass filtering operation to the synchronization circuit and the cancellation circuit.

7. The electronic device of claim 4, wherein the logic circuit multiplies a square of the DGL component by a conjugate of the transmission signal based on that the transmission channel is located in a lower frequency range than the reception channel.

8. The electronic device of claim 1, further comprising a second low-pass filter outputting the second IMD component filtered through a low-pass filtering operation to the cancellation circuit.

9. The electronic device of claim 4, wherein the filter circuit further comprises:
a first down sampler down-sampling the transmission signal and outputting the down-sampled transmission signal to the first delay circuit; and
a second down sampler down-sampling the DGL component and outputting the down-sampled DGL component to the second delay circuit.

10. A method of cancelling self-interference in a reception signal of an electronic device, comprising:
extracting a duplex gap leakage (DGL) component present between a transmission channel for a transmission signal and a reception channel for the reception signal, from the reception signal;
modeling a first intermodulation distortion (IMD) component of the reception signal based on the transmission signal and the DGL component to generate a second IMD component;
digitally filtering the second IMD component to generate a filtered IMD component; and
cancelling the filtered IMD component from the reception signal.

11. The method of claim 10, further comprising:
outputting a first delay value and a second delay value for a time synchronization between the first IMD component and the second IMD component, wherein the first delay value is to be applied to the transmission signal, and the second delay value is to be applied to the DGL component.

12. The method of claim 11, wherein the outputting of the first and second delay values further comprises:
calculating correlation output values through a correlation calculation of the first IMD component and the second IMD component; and
outputting the first and second delay values among the calculated correlation output values that exceed a threshold.

13. The method of claim 12, further comprising:
delaying the transmission signal based on the first delay value to generate a delayed transmission signal;
shifting a center frequency of the reception signal to a center frequency of the DGL component to generate a shifted reception signal;
outputting the DGL component through a lower pass filtering operation of the shifted reception signal;
delaying the DGL component based on the second delay value to generate a delayed DGL component; and
modeling the first IMD component based on the delayed transmission signal and the delayed DGL component.

14. The method of claim 10,
wherein the digitally filtering is performed based on a digital filter comprising a plurality of memory taps, and the method further comprises reducing an error between the first IMD component and the second IMD component based on adjusting at least one of tap coefficients of the memory taps.

15. The method of claim 13, wherein the modeling of the first IMD component comprises:
multiplying a square of the DGL component by a conjugate of the transmission signal based on that the transmission channel is located in a lower frequency range than the reception channel; and
multiplying a conjugate of the DGL component by a square of the transmission signal based on that the transmission channel is located in a higher frequency range than the reception channel.

16. A wireless communication device comprising:
a front-end module configured to separate a transmission channel from a reception channel, to transmit a transmission signal to the transmission channel, and to receive a reception signal from the reception channel;
a radio frequency integrated chip (RFIC) configured to perform a frequency conversion and an analog-to-digital conversion on the transmission signal and the reception signal; and
a processor, based on the transmission signal and a duplex gap leakage (DGL) component present between the transmission channel and the reception channel in a digital domain according to the analog-to-digital conversion, configured to model a first intermodulation distortion (IMD) component of the reception signal to generate a second IMD component, to digitally filter the first IMD component to generate a filtered IMD component, and to cancel the filtered IMD component from the reception signal.

17. The wireless communication device of claim 16, wherein the processor applies a first delay value for a time synchronization of the first IMD component and the second IMD component to the transmission signal and applies a second delay value for the time synchronization to the DGL component.

18. The wireless communication device of claim 16, wherein the processor is configured to shift a center frequency of the reception signal to a center frequency of the DGL component and to obtain the DGL component by low-pass filtering the shifted reception signal.

19. The wireless communication device of claim 17, wherein the processor is configured to model the first IMD component based on the transmission signal to which the first delay value is applied and the DGL component to which the second delay value is applied.

20. The wireless communication device of claim 16, wherein the front-end module comprises a DGL filter that filters the DGL component, and the RFIC transmits the DGL component output from the DGL filter to the processor.
